(19) United States
(12) Patent Application Publication
(10) Pub. No.: US 2020/0086402 A1
(43) Pub. Date: Mar. 19, 2020

(54) DRILL CHUCK ADAPTOR SYSTEM AND METHOD

(71) Applicant: Steve Dragon, Edmonton AB (CA)

(72) Inventor: Steve Dragon, Edmonton AB (CA)

(21) Appl. No.: 16/143,375

(22) Filed: Sep. 26, 2018

(30) Foreign Application Priority Data
Sep. 13, 2018 (CA) 3,017,278

(51) Int. Cl. B23B 51/12; B23B 31/00

(52) U.S. Cl. CPC B23B 51/12; B23B 2231/04; B23B 31/008

(57) ABSTRACT

A drill chuck adaptor system including: a drill chuck adaptor tool including a socket body, a lug-receiver, and a threaded-member; as such the drill chuck adaptor system enables the drill chuck adaptor tool for effective use. The drill chuck adaptor tool is defined by the socket body, the lug-receiver, and the threaded-member; the lug-receiver, and the threaded-member extending outwardly from (on) opposing ends of the socket body. The socket body is removably couplable to an impact-driver-tool via a lug of the impact-driver-tool being received by the lug-receiver and the threaded-member is able to be removably coupled to a drill chuck such that the drill chuck is able to be driven via the impact-driver-tool.

### BACKGROUND OF THE INVENTION

This application claims benefit under 35 USC 119 to Canada National Application No. 3,017,278 filed on Sep. 13, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of chucks or sockets of existing art and more specifically relates to chucks or sockets with loose jaws.

### RELATED ART

Many individuals use tools to perform jobs. Drilling operations in construction generally make use of an electric drill with a chuck that tightens around the drill bit to be used. When it is desirable to change drill bits or to remove the drill bit from use the chuck is opened and the drill bit released. The drill is often considered to be a single-purpose tool. Having a more versatile means to perform drilling would be desirable to save money and time on projects. A suitable solution is desired.

U.S. Pat. No. 386,185 relates to a drill-chuck and interchangeable drill holders for holding broken, taper, or straight shank drills, and has for its object to provide a chuck into which a series of drill holders may be inserted and securely fastened, that shall be adapted to grasp and firmly hold drills with different formations of shank, as well as the twist end of the drill when broken from the shank, thereby rendering it possible to employ drills having shanks of different forms in the same chuck, as well as to utilize that portion of the drill heretofore considered worthless.

### SUMMARY OF THE INVENTION

In view of the foregoing disadvantages inherent in the known chucks or sockets art, the present disclosure provides a novel drill chuck adaptor system. The general purpose of the present disclosure, which will be described subsequently in greater detail, is to provide versatile use of tools in drilling operations.

A drill chuck adaptor system is disclosed herein comprising: a drill chuck adaptor tool including a socket body, a lug-receiver, and a threaded-member; as such the drill chuck adaptor system comprises the drill chuck adaptor tool for effective use. The drill chuck adaptor tool is defined by the socket body, the lug-receiver, and the threaded-member; the lug-receiver, and the threaded-member extending outwardly from (on) opposing ends of the socket body. The socket body is removably couplable to an impact-driver-tool via a lug of the impact-driver-tool being received by the lug-receiver and the threaded-member is able to be removably coupled to a drill chuck such that the drill chuck is able to be driven via the impact-driver-tool.

An adaptor system is also described herein comprising: an adaptor tool: including a socket body, a lug-receiver, and a connected-drill-bit; wherein the adaptor system comprises the adaptor tool. The adaptor tool is defined by the socket body, the lug-receiver, and the connected-drill-bit; the lug-receiver and the connected-drill-bit extending outwardly from opposing ends of the socket body. In this embodiment the socket body is removably couplable to an impact-driver-tool via a lug of the impact-driver-tool being received by the lug-receiver such that the connected-drill-bit is able to be driven via the impact-driver-tool. This particular embodiment does not use a drill chuck as in the first embodiment.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a drill chuck adaptor system, constructed and operative according to the teachings of the present disclosure.

FIG. 1 is a perspective view of the drill chuck adaptor system during an ‘in-use’ condition, according to an embodiment of the disclosure.

FIG. 2 is a perspective view of the drill chuck adaptor system of FIG. 1, according to an embodiment of the present disclosure.

FIG. 3 is a perspective view of the drill chuck adaptor system of FIG. 1, according to an embodiment of the present disclosure.

FIG. 4 is a perspective view of the drill chuck adaptor system of FIG. 1, according to an embodiment of the present disclosure.

FIG. 5 is a perspective view of an adaptor system of FIG. 1, according to an alternate embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to chucks or sockets and more particularly to a drill chuck adaptor system as used to improve the versatility in drilling and cutting processes. Generally, the present invention allows for a drill chuck to be used on an impact wrench.

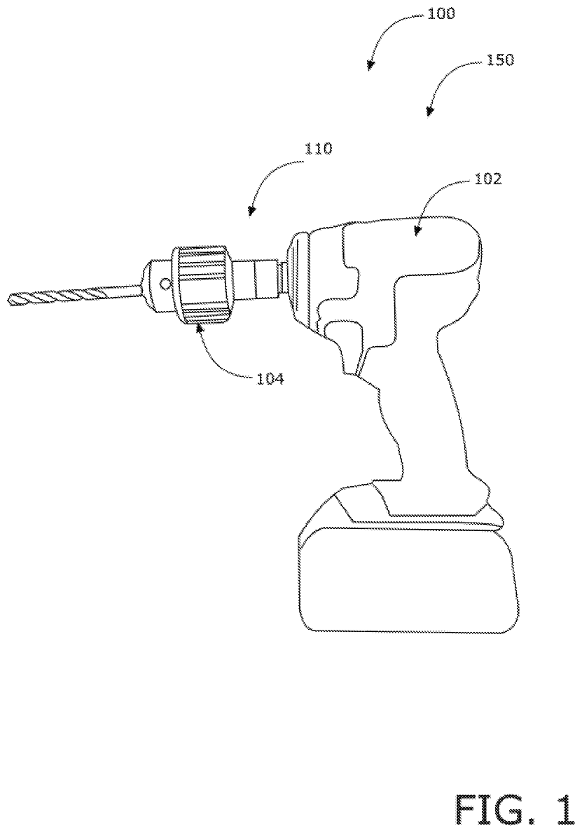

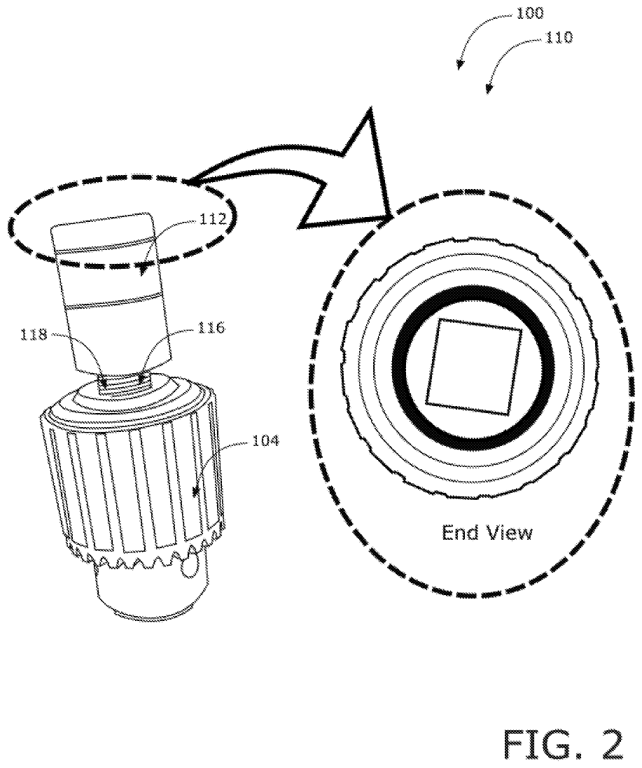

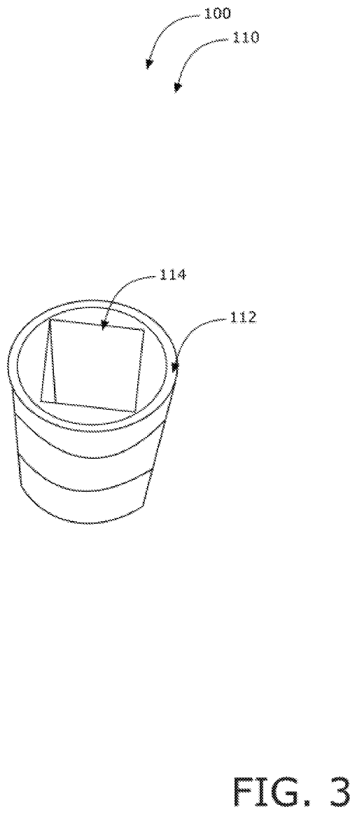

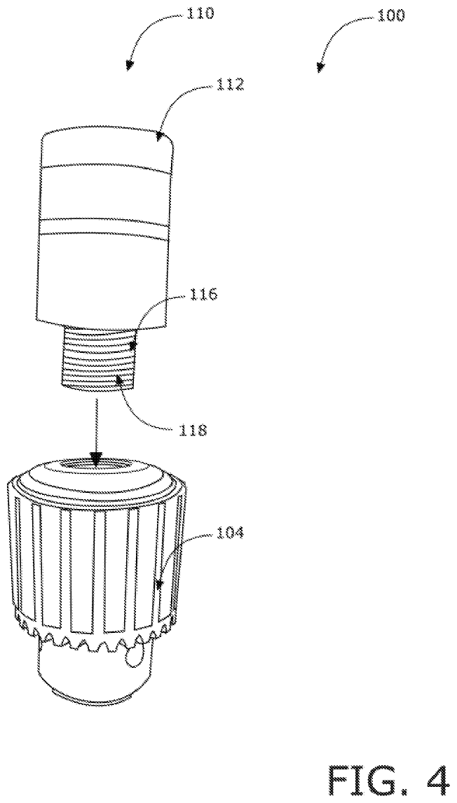

Referring now more specifically to the drawings by numerals of reference, there is shown in FIGS. 1-4, various views of a drill chuck adaptor system 100.

FIG. 1 shows a drill chuck adaptor system 100 during an ‘in-use’ condition 150, according to an embodiment of the present disclosure. Here, the drill chuck adaptor system 100 may be beneficial for use by a user to perform drilling and cutting operations with an impact-driver-tool 102. As illustrated, the drill chuck adaptor system 100 may include a drill chuck adaptor tool 110 including a socket body 112, a lug-receiver 114, and a threaded-member 116; as such the drill chuck adaptor system 100 comprises the drill chuck adaptor tool 110 for effective use with impact-driver-tool 102. The drill chuck adaptor tool 110 is defined by the socket body 112, the lug-receiver 114, and the threaded-member 116. The lug-receiver 114, and the threaded-member 116 extend outwardly (180 degrees in relation to each other) from opposing ends of the socket body 112. The socket body 112 is removably couplable to an impact-driver-tool 102 via a lug of the impact-driver-tool 102 being received by the lug-receiver 114 and the threaded-member 116 being able to be removably coupled to a drill chuck 104 such that the drill chuck 104 is able to be driven via the impact-driver-tool 102.

Referring now to the lug-receiver 114 of the drill chuck adaptor system 100; the lug-receiver 114 preferably comprises a negative 3D cubic volume; however other shapes may be used. The threaded-member 116 comprises external threads 118 in preferred embodiments however other suitable attaching means may be used. The external threads 118 may comprise imperial-threads; metric-threads; fine threads; and course threads or the like. The external threads 118 are able to be received by the drill chuck 104; wherein the drill chuck 104 is useful for gripping drill-bits, or non-drill-bits. The drill-bits are used in drilling processes and the non-drill-bits are useful for cutting processes or the like. For ease of use an extension may be used with the drill chuck adaptor tool 110 and the impact-driver-tool 102. The threaded-member 116 may be a stud or integral with the socket body 112.

A preferred embodiment of the drill chuck adaptor system 100 comprises: a drill chuck adaptor tool 110 including a socket body 112, a lug-receiver 114, and a threaded-member 116; wherein the drill chuck adaptor system 100 comprises the drill chuck adaptor tool 110. The drill chuck adaptor tool 110 is defined by the socket body 112, a lug-receiver 114, and a threaded-member 116; the lug-receiver 114, and the threaded-member 116 extending outwardly from opposing ends of the socket body 112, as shown. The lug-receiver 114 comprises a negative 3D cubic volume, and the threaded-member 116 comprises external threads 118. The external threads 118 are received by the drill chuck 104; wherein the drill chuck 104 is useful for gripping drill-bits and non-drill-bits. The drill-bits are used in drilling processes and the non-drill-bits are useful for cutting processes. An extension may be used with the drill chuck adaptor tool 110 and the impact-driver-tool 102 for instances when locations are difficult to reach. As above, the threaded-member 116 is preferably integral with the socket body 112.

According to one embodiment, the drill chuck adaptor system 100 may be arranged as a kit. In particular, the drill chuck adaptor system 100 may further include a set of instructions. The instructions may detail functional relationships in relation to the structure of the drill chuck adaptor system 100 such that the drill chuck adaptor system 100 can be used, maintained, or the like, in a preferred manner.

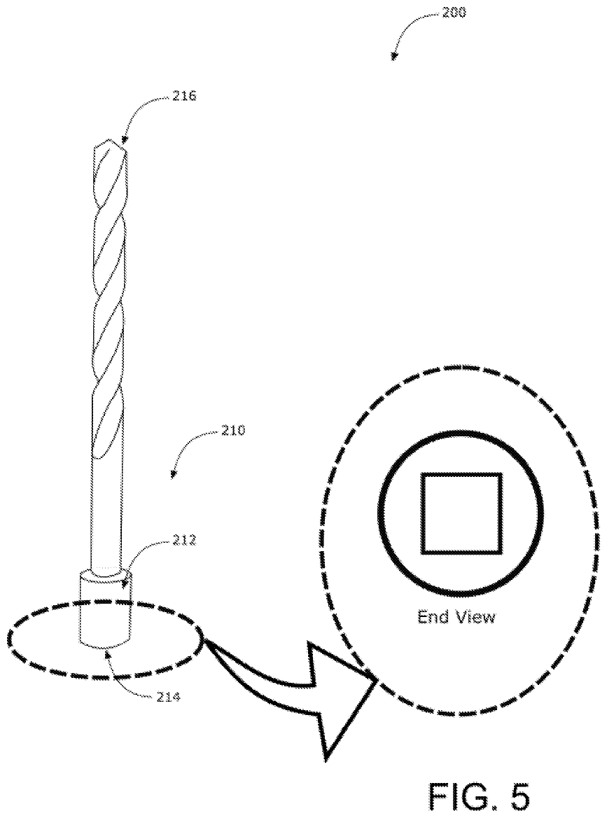

Referring now to FIG. 5 shows various views of the adaptor system 200 according to an embodiment of the present disclosure.

The adaptor system 200 comprises: an adaptor tool 210 including a socket body 212, a lug-receiver 214, and a connected-drill-bit 216; wherein the adaptor system 200 comprises the adaptor tool 210. The adaptor tool 210 is defined by the socket body 212, the lug-receiver 214, and the connected-drill-bit 216; the lug-receiver 214, and the connected-drill-bit 216 extending outwardly (at 180 degrees to one another) from opposing ends of the socket body 212. In this embodiment the socket body 212 is removably couplable to an impact-driver-tool 102 via a lug of the impact-driver-tool 102 being received by the lug-receiver 214 such that the connected-drill-bit 216 is able to be driven via the impact-driver-tool 102. This particular embodiment does not use a drill chuck 104 as in the first embodiment. The connected-drill-bit 216 may or may not comprise flutes.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An adaptor for an impact driver tool, comprising:
a body, the body having a first end with a lug receiver which is removably couplable to the impact driver tool and a second end opposite to the first end the second end adapted to secure a tool bit; and
a tool bit, the tool bit having a first attachment end adapted to secure to the second end of the body.

2. The adaptor of claim 1, wherein the tool bit is a drill chuck.

3. The adaptor of claim 1, wherein the tool bit is a drill bit.

4. The adaptor of claim 1, wherein the tool bit is a second adaptor for a drill chuck.

5. The adaptor of claim 1, wherein the tool bit is detachably couplable to the body.

6. A drill chuck adaptor system comprising:
a drill chuck adaptor tool including
a socket body;
a lug-receiver; and
a threaded-member;
wherein said drill chuck adaptor system comprises said drill chuck adaptor tool;
wherein said drill chuck adaptor tool is defined by said socket body, said lug-receiver, and said threaded-member, said lug-receiver, and said threaded-member extending outwardly from opposing ends of said socket body; and
wherein said socket body is removably couplable to an impact-driver-tool via a lug of said impact-driver-tool being received by said lug-receiver and said threaded-member able to be removably coupled to a drill chuck such that said drill chuck is able to be driven via said impact-driver-tool.

7. The drill chuck adaptor system of claim 6, wherein said lug-receiver comprises a negative 3D cubic volume.

8. The drill chuck adaptor system of claim 6, wherein said threaded-member comprises external threads.

9. The drill chuck adaptor system of claim 8, wherein the external threads are received by said drill chuck.

10. The drill chuck adaptor system of claim 6, wherein the drill chuck is useful for gripping drill-bits.

11. The drill chuck adaptor system of claim 6, wherein the drill chuck is useful for gripping non-drill-bits.

12. The drill chuck adaptor system of claim 10, wherein the drill-bits are used in drilling processes.

13. The drill chuck adaptor system of claim 11, wherein the non-drill-bits are useful for cutting processes.

14. The drill chuck adaptor system of claim 6, wherein an extension may be used with the drill chuck adaptor tool and the impact-driver-tool.

15. The drill chuck adaptor system of claim 6, wherein the threaded-member is a stud.

16. The drill chuck adaptor system of claim 6, wherein the threaded-member is integral with said socket body.

17. An adaptor system comprising:
an adaptor tool including
a socket body;
a lug-receiver; and
a connected-drill-bit;
wherein said adaptor system comprises said adaptor tool;
wherein said adaptor tool is defined by said socket body, said lug-receiver, and said connected-drill-bit, said lug-receiver, and said connected-drill-bit extending outwardly from opposing ends of said socket body; and
wherein said socket body is removably couplable to an impact-driver-tool via a lug of said impact-driver-tool being received by said lug-receiver such that said connected-drill-bit is able to be driven via said impact-driver-tool.

18. The drill chuck adaptor system of claim 17, further comprising set of instructions; and
wherein the drill chuck adaptor system is arranged as a kit.
